(19) United States
(12) Patent Application Publication
(10) Pub. No.: US 2004/0047945 A1
(43) Pub. Date: Mar. 11, 2004

(54) Use of tannins and polymers to regulate digestion in animals

(76) Inventors: Stephen E. Bachman, Amarillo, TX (US); Michael E. Hubbert, Amarillo, TX (US)

Correspondence Address: Dale F Regelman, Law Office of Dale F Regelman, 4231 South Fremont Avenue, Tucson, AZ, 85714, US

(21) Appl. No.: 10/466,005

(22) PCT Filed: Jan. 10, 2002
(86) PCT No.: PCT/US02/00884

(51) Int. Cl. A01K 1/00

(52) U.S. Cl. 426/2

(57) ABSTRACT

A method to adjust the digestibility of food ingested by an animal, where that method includes the steps of forming a feed composition comprising one or more tannins, and feeding that feed composition to an animal. A method to adjust the digestibility of food ingested by an animal, where that method includes the steps of forming a feed composition comprising poly-2-ethyl-2-oxazoline, and feeding that feed composition to an animal. A feed composition for animals which includes poly-2-ethyl-2-oxazoline.

### FIELD OF THE INVENTION

Applicants' invention relates to a method to adjust food digestion in animals by adding one or more tannins, and or tannin derivatives, and/or water soluble polymers to the animals' diet to influence fermentation, absorption and digestion of foodstuffs and/or fermentation by-products.

### BACKGROUND OF THE INVENTION

Tannins comprise a large and diverse class of naturally-occurring compounds. It is thought that tannins act as a defense mechanism in plants against pathogens, herbivores and hostile environmental conditions.

There are three large classes of secondary metabolites in plants, including nitrogen containing compounds, terpenoids, and phenolics. Tannins belong to the phenolics class. All phenolic compounds (primary and secondary) are, in one way or another, formed via the shikimic acid pathway, also known as the phenylpropanoid pathway. This same metabolic pathway leads to the formation of other phenolics such as isoflavones, coumarins, lignins and aromatic amino acids, such as tryptophan, phenylalanine and tyrosine.

Tannins comprise a broad class of oligomeric compounds having multiple structure units with free phenolic groups. Compounds properly classified as tannins may have molecular weights ranging from 500 to >20,000. In general, tannins are soluble in water, with the exception of certain high molecular weight compounds. In addition, tannins can bind proteins and form insoluble or soluble tannin-protein complexes.

Two main categories of tannins include hydrolyzable tannins (HTs) and condensed tannins, identified more correctly as proanthocyanidins (PAs). Condensed tannins are resistant to hydrolytic degradation.

Hydrolyzable tannins comprise molecules having a polyol (generally D-glucose) as a central core. Many such hydrolyzable tannins comprise substituted carbohydrate, i.e. D-glucose, moieties. The hydroxyl groups of these carbohydrates are partially or totally esterified with substituted aromatic acids and/or lactones such as gallic acid I or ellagic acid II.

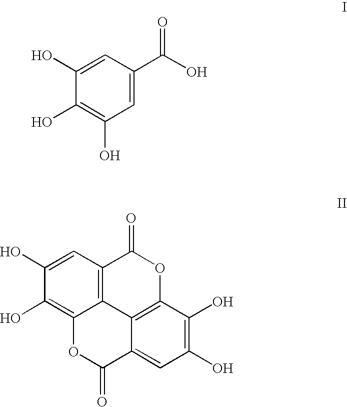

Gallotannins comprise compounds formed by reaction of a polyol with one or more gallic acid equivalents. Ellagitannins comprise compounds formed by reaction of a polyol with one or more ellagic acid equivalents. The ellagitannins have molecular weights in the range of about 2,000 to about 5,000.

Two additional classes of hydrolyzable tannins, include taragallotannins, comprising the reaction product between a polyol and both gallic acid I and quinic acid III, and caffetannins comprising quinic acid III and caffeic acid IV.

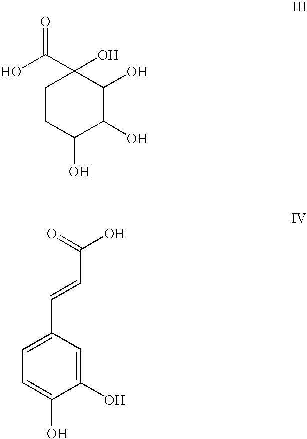

With respect to the family of compounds comprising the gallotannins, the phenolic groups that esterify the polyol core sometimes comprise dimers or higher oligomers of gallic acid (each single monomer is called galloyl). In addition, each HT molecule usually comprises a core D-glucose moiety in combination with 6 to 9 galloyl groups. It should, however, be noted that in nature there exist an abundance of mono- and di-galloyl esters of glucose (MW about 900). These compounds are not considered tannins, and do not fall within Applicants' invention. As a general rule, at least 3 hydroxyl groups of the polyol core must be esterified to exhibit a sufficiently strong binding capacity so as to be classified as a tannin. The most famous source of gallotannins is tannic acid which is obtained from the twig galls of Rhus semialata. Tannic acid comprises a penta-galloyl-D-glucose core with one of those primary galloyl units having an oligomeric unit extending therefrom, wherein that oligomeric unit is formed from five additional gallic acid moieties in linear combination.

As a group, the hydrolyzable tannins can be cleaved by mild acids or mild bases to yield the constituent carbohydrate(s) and phenolic acids. HTs are also hydrolyzed by hot water or enzymes (i.e. tannase). Under the same conditions, however, proanthocyanidins (condensed tannins) do not hydrolyze.

PAs are more widely distributed than HTs. They are oligomers or polymers of flavonoid units such as flavan-3-ol, compound V, linked by carbon-carbon bonds not susceptible to cleavage by hydrolysis.

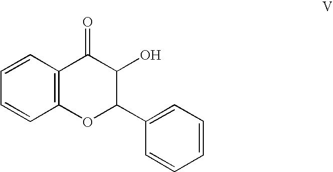

PAs are more often called condensed tannins due to their condensed chemical structure. However, HTs also undergo condensation reaction. The term, condensed tannins, is therefore potentially confusing.

The term, proanthocyanidins, is derived from the acid catalyzed oxidation reaction that produces red anthocyanidins upon heating PAs in acidic alcohol solutions. The most common anthocyanidins produced are cyanidin (flavan-3-ol, from procyanidin) and delphinidin (from prodelphinidin). PAs may contain from 2 to 50 or greater flavonoid units. PA polymers have complex structures because the flavonoid units can differ for some substituents and because of the variable sites for interflavan bonds. FIG. 1 shows one such typical PA compound.

Anthocyanidin pigments are responsible for the wide array of pink, scarlet, red, mauve, violet, and blue colors in flowers, leaves, fruits, fruit juices, and wines. They are also responsible for the astringent taste of fruit and wines. PA carbon-carbon bonds are not cleaved by hydrolysis. Depending on their chemical structure and degree of polymerization, PAs may or may not be soluble in aqueous and/or organic solvents.

Tannins have a major impact on animal nutrition because of their ability to form complexes with numerous types of molecules, including, but not limited to, carbohydrates, proteins, polysaccharides, bacterial cell membranes, and enzymes involved in protein and carbohydrates digestion.

The prior art generally teaches that tannins negatively affect an animal's feed intake, feed digestibility, and efficiency of production. The effects vary depending on the content and type of tannin ingested and on the animal's tolerance, which in turn is dependent on characteristics such as type of digestive tract, feeding behavior, body size, and detoxification mechanisms.

Because of the bitter taste associated with tannins, animals tend to eat lesser amounts of foodstuffs containing tannins. Mastication ruptures the plant cell tissue and exposes proteins and carbohydrates to tannins. Thus, the inclusion of tannins in an animal's food, and the resulting decreased palatability of that food, can have an immediate result, i.e. less food consumed. Palatability is reduced because tannins are astringent. Astringency is the sensation caused by the formation of complexes between tannins and salivary glycoproteins.

In addition, because of certain antinutritional/toxic effects of the tannins consumed, animals consuming tannins may experience delayed responses as well. For example, tannins can form chemical complexes with dietary proteins and metabolic proteins, including bacteria, enzymes, and epithelial cells.

Digestibility reduction negatively influences intake because of the filling effect associated with undigested feedstuff. Several studies have reported higher feed intakes and weight gains when tannin-free diets were compared to tannin-containing ones. Some caution must be taken when interpreting these results. In many trials, commercial tannins sources were used. These types of tannins are usually more effective at lowering feed intakes than naturally-occurring tannins. In addition, in many such trials only extractable tannins are measured and insoluble tannins are not quantified. However, insoluble tannins may have equal or greater biological activity than those that are more easily extracted.

Applicants' have found that inclusion of naturally-occurring tannins in animal foods does not always reduce intake. Rather, tannin-rich diets were eaten in equal or larger amounts than low or free tannin diets. Thus, the form in which the forage is fed may influence how tannins affect feed intake. For example, forages rich in tannins are eaten in larger amounts when field dried rather than fresh frozen. Indeed, drying reduces the solubility of tannins and, hence, reduces their ability to complex proteins. Certain tannins can polymerize thereby lowering the free hydroxyl groups available for binding proteins.

In addition, intake in animal diets rich in tannins can be increased by using a compound with a high affinity for tannins, like PEG (polyethylene glycol). PEG has a higher affinity to tannins than do proteins. PEG can be sprayed on the forages or added in the diet and is fairly inexpensive. PEG utilization can increase feed palatability and digestibility and result in higher animal productivity.

On the other hand, feed intake may be decreased by the presence of low molecular weight phenolic compounds. These low molecular weight phenolics predominate during the early stages of plant growth and are then converted to oligomers and finally to higher molecular weight, polymeric tannins when the plant matures. These low molecular weight phenolics are more readily absorbed into the body, and cause systemic effects such as alteration of physiological systems, increased energy requirements due to detoxification, and subsequent growth rate reduction.

Tannin solubility plays a role in determining a tannin's efficiency in binding proteins and/or fiber. If the ratio of soluble to insoluble tannins is high, then protein digestibility is affected more than fiber digestibility. On the other hand, if the same ratio is low, fiber digestibility is the most affected.

Tannin toxicity to rumen microorganisms has been described for several bacteria species such as Streptococcus bovis, Butyvibrio fibrosolvens, Fibrobacter succinogenes, Prevotella ruminicola, and Ruminobacter amylophilis. Three mechanisms of toxicity have been identified and include, enzyme inhibition and substrate deprivation, action on membranes, and metal ion deprivation.

Tannins induce changes in morphology of several species of ruminal bacteria. Certain microorganisms have developed defense mechanisms, including: (i) secretion of binding polymers that complex with tannins, (ii) synthesis of tannin-resistant enzymes, and (iii) biodegradation of tannins (peculiarity of some recently discovered bacteria that are able to tolerate high levels of PA).

Hydrolyzable tannins are toxic to ruminants. Tannin toxicity from HTs may occur in animals fed oak (Quercus spp.) and several tropical tree legumes (e.g. Terminalia oblongata and Clidema hirta). Microbial metabolism and gastric digestion convert HTs into absorbable low molecular weight metabolites. Some of these metabolites are toxic. The major lesions associated with HT poisoning are hemorrhagic gastroenteritis, necrosis of the liver, and kidney damage with proximal tuberal necrosis. High mortality and morbidity were observed in sheep and cattle fed oaks and other tree species with more than 20% HT.

The toxicity resulting from ingestion of PAs is difficult to separate from their effects on the digestion of proteins and carbohydrates. PAs are not absorbed by the digestive tract. PAs may, however, damage the mucosa of the gastrointestinal tract, decreasing the absorption of nutrients. In addition, PAs may reduce the absorption of essential amino acids. The most susceptible amino acids are methionine and lysine. Decreased methionine availability could increase the toxicity of cyanogenic glycosides, because methionine is involved in the detoxification of cyanide via methylation to thiocyanate.

According to the prior art, monogastric animals fed diets with a level of tannins under 5% experience depressed growth rates, low protein utilization, damage to the mucosal lining of the digestive tract, alteration in the excretion of certain cations, and increased excretion of proteins and essential amino acids. In poultry, for example, small quantities of tannins in the diet cause adverse effects. Specifically, levels from 0.5 to 2.0% can cause depression in growth and egg production, and levels from 3 to 7% can cause death. In swine, similar harmful effects of tannins have been found. The addition of additional proteins or amino acids may alleviate the antinutritional effects of tannins. As a general matter, levels of tannins above 5% of the diet are often lethal.

Many animals have developed certain defense mechanisms to combat the toxic effects of tannin ingestion. For example, some insects consume leaves with high levels of tannins. These insects are able to adapt to tannins using several available mechanisms, including: (i) having an alkaline gut pH, (ii) use of surfactants to decrease affinity between ingested tannins and protein, (iii) increased presence of peritrophic membranes that absorb tannins and are then excreted in the feces.

Many tannin-consuming animals secrete a tannin-binding protein (mucin) in their saliva. The tannin-binding capacity of salivary mucin is directly related to its proline content. The advantages in using salivary proline-rich proteins (PRPs) to inactivate tannins include: (i) PRPs inactivate tannins to a greater extent than do dietary proteins thereby resulting in reduced fecal nitrogen losses, (ii) PRPs contain non specific nitrogen and nonessential amino acids, thereby making them more convenient for an animal to exploit rather than using up valuable dietary protein.

There are differences in the amount of PRP that different species produce to bind tannins. For example, the ability to tolerate tannins differs in the order: deer>goat>sheep>cattle. In addition, consumption of high tannin diets stimulates the development of the salivary glands to permit more PRP production.

Tannins have a major impact on animal nutrition because of their ability to form complexes with numerous types of molecules, including, but not limited to, carbohydrates, proteins, polysaccharides, bacterial cell membranes, and enzymes involved in protein and carbohydrates digestion.

With respect to carbohydrates, both starch and cellulose are complexed by tannins (especially by PAs). Starch has the ability to form hydrophobic cavities that allow inclusion complexes with tannins and many other lipophyllic molecules. Only starch, among the molecules that are bound by tannins, has this embedding characteristic. On the other hand, cellulose has a direct surface interaction with tannins.

The cell wall carbohydrate-tannin interaction is less understood. One explanation is that tannins associate with plant cell walls in a manner reminiscent to that of lignin. However, another explanation is that this association is merely an artifact of tannin isolation from non-living cells. Indeed, the location of tannins and cell wall carbohydrates is quite different in living cells than in plant cells after digestion by animals. Tannin-carbohydrate interactions are increased by carbohydrates with high molecular weight, low solubility and conformational flexibility. These interactions are probably based on hydrophobic and hydrogen linkages.

The capacity of tannins to bind proteins has been recognized for centuries. Leather tanning is a very ancient practice. Tannin-protein interactions are specific and depend on the structure of both the protein and tannin. Protein characteristics that favor strong bonding include: (i) large molecular size, (ii) open and flexible structures, and (iii) richness in proline. Tannin characteristics that favor strong bonding include: (i) high molecular weight, and (ii) high conformational mobility.

Tannin-protein interactions are most frequently based on hydrophobic and hydrogen bonding. Ionic and covalent bonding occur less frequently. The tannin's phenolic group is an excellent hydrogen donor that forms strong hydrogen bonds with the protein's carboxyl group. For this reason, tannins have a greater affinity to proteins than to starch. Hydrophobic bonds are stronger at higher ionic strength (higher tannin/protein ratios) and higher temperatures. Covalent bonding occurs only under oxidizing conditions including: (i) autoxidation over time, or (ii) action of oxidative enzymes (i.e. polyphenoloxydases and peroxidases). Covalent bonding is far more difficult to disrupt than the previous types of bonding and is nutritionally very important because of its irreversible nature.

Precipitation of proteins by tannins is maximum at pH values near the isoelectric point of the protein. In solution at high pH, phenolic hydroxyls are ionized and proteins have net negative charges. Under these conditions, precipitation does not occur because proteins exhibit repulsive forces. Strong complexes with tannins are formed by tannin-binding agents like polyvinylpyrrolidone (PVP) and polyethylene glycol (PEG), and protein denaturants like phenol. To have high protein affinity, tannins must be small enough to penetrate interfibrillar region of protein molecules but large enough to crosslink peptide chains at more than one point.

HTs and PAs form tannin-protein complexes in similar manners. Proteins thus bound are generally resistant to attack by proteases and hence may be unavailable for livestock nutrition. However, it is hypothesized that HTs may have a less damaging effect on protein digestion because these tannins may hydrolyze in the acidic gastric environment and release the bound proteins. When soluble tannins interact with proteins, both soluble and insoluble complexes are formed; their relative proportion depends on the concentration and size of both molecules.

Soluble complexes are favored when protein concentration is in excess (fewer tannin attachment sites per each protein molecule). Soluble complexes represent an analytical problem because they do not precipitate and, thus, are difficult to measure. Insoluble complexes are formed when tannins are present in excess and form an hydrophobic outer layer in the complex surface.

According to the prior art, the presence of tannins in food sources for monogastric animals, is generally viewed adversely. Ironically, the preferred inclusion of certain tannins in red wines consumed by humans is certainly an exception.

The prior art further teaches that tannins and their derivatives are known for their negative influence on digestion. Applicants have found, however, these negatives aspects are a positive if the tannins are identified and supplemented to the animals in the proper proportions for the desired effects. Antibiotics are added to animal feeds to alter microbial populations and reduce intake in animals. These compounds have many of the same negative effects that natural occurring tannins elicit.

Currently, some initial steps have been taken in plant breeding to increase the tannins in fodder grazed by animals to reduce the incidence of pasture bloat. Applicants have found that identification and purification, and/or chemical synthesis of naturally occurring tannins can enhance animal health and, thereby, production increases. The proliferation of genetically engineered bacteria, yeast, fungi and plants are also methods of naturally packaging tannins for the purpose of diet supplementation.

### SUMMARY OF THE INVENTION

Applicants' invention includes a method to adjust the digestibility of food ingested by an animal, where that method includes the steps of forming a feed composition comprising one or more tannins, and feeding that feed composition to an animal. Applicants' invention further includes a method to adjust the digestibility of food ingested by an animal, where that method includes the steps of forming a feed composition comprising poly-2-ethyl-2-oxazoline, and feeding that feed composition to an animal. Applicants' invention further includes a feed composition for animals which includes poly-2-ethyl-2-oxazoline.

### BRIEF DESCRIPTION OF THE DRAWINGS

The invention will be better understood from a reading of the following detailed description taken in conjunction with the drawings in which like reference designators are used to designate like elements, and in which:

FIG. 1 shows the structure of a typical condensation tannin;

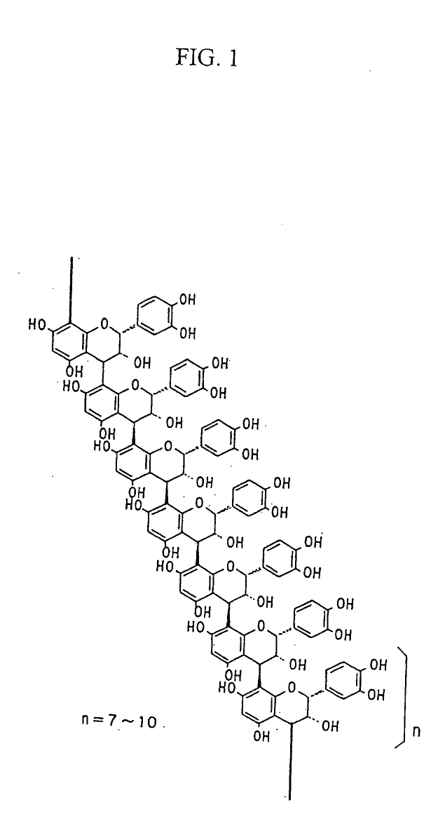

FIG. 2 graphically depicts in vitro dry matter disappearance data obtained for three (3) wheat forage-based feed compositions each of which includes about 1% tannins;

FIG. 3A recites formulations for Applicants' tannin-modified, and/or PEOX-modified, feed compositions;

FIG. 3B recites formulations for Applicants' tannin-modified, and/or PEOX-modified, feed compositions;

FIG. 4 graphically depicts in vitro dry matter disappearance data obtained in a first experiment for steam-flaked corn treated with about 1% PEOX;

FIG. 5 graphically depicts in vitro dry matter disappearance data obtained in a first experiment for steam-flaked corn treated with about 5% PEOX;

FIG. 6 graphically depicts in vitro dry matter disappearance data obtained in a second experiment for steam-flaked corn treated with about 1% PEOX, where that PEOX was added as a dry material;

FIG. 7 graphically depicts the enhanced digestibility of the 1% PEOX-treated steam-flaked corn feed material of FIG. 6;

FIG. 8 graphically depicts in vitro dry matter disappearance data obtained in a second experiment for ground corn treated with about 1% PEOX, where that PEOX was added as a dry material;

FIG. 9 graphically depicts the enhanced digestibility of the 1% PEOX-treated ground corn feed material of FIG. 8;

FIG. 10 graphically depicts in vitro dry matter disappearance data obtained in a second experiment for steam-flaked corn treated with about 1% PEOX, where that PEOX was added as a solution;

FIG. 11 graphically depicts the enhanced digestibility of the 1% PEOX-treated flaked corn feed material of FIG. 10;

FIG. 12 graphically depicts in vitro dry matter disappearance data obtained in a second experiment for steam-flaked corn treated with about 5% PEOX, where that PEOX was added as a dry material;

FIG. 13 graphically depicts the enhanced digestibility of the 5% PEOX-treated steam-flaked corn feed material of FIG. 12;

FIG. 14 graphically depicts in vitro dry matter disappearance data obtained in a second experiment for ground corn treated with about 5% PEOX, where that PEOX was added as a dry material;

FIG. 15 graphically depicts the enhanced digestibility of the 5% PEOX-treated flaked corn feed material of FIG. 14;

FIG. 16 graphically depicts in vitro dry matter disappearance data obtained in a second experiment for steam-flaked corn treated with about 5% PEOX, where that PEOX was added as a solution; and

FIG. 17 graphically depicts the enhanced digestibility of the 5% PEOX-treated flaked corn feed material of FIG. 16.

### DETAILED DESCRIPTION OF THE PREFERRED EMBODIMENTS

Applicants have found that use of tannins, or their derivatives, alone, or in combination with certain water soluble polymers, and/or poly-2-ethyl-2-oxazoline, when added to animal feed compositions can positively: (i) alter microbial populations of the digestive system, (ii) alter microbial fermentation patterns, (iii) alter site of absorption of nutrients, (iv) alter absorption of nutrients, (v) regulate digestion, and (vi) treat metabolic disorders such as bloat and/or acidosis. In addition, Applicants have found that tannins can be used to by-pass rumen fermentation by binding the protein, starch, enzyme, or compound for digestion post-ruminally.

The following examples are presented to further illustrate to persons skilled in the art how to make and use the invention and to identify presently preferred embodiments thereof. These examples are not intended as a limitation, however, upon the scope of Applicants' invention.

### EXAMPLE I

In Vitro Dry Matter Disappearance (“IVDMD”) experiments were conducted for each of three (3) feed compositions containing about 1% tannins. The following IVDMD procedures were the same in each experiment. Each experiment consisted of two IVDMD runs conducted on two separate days. Hence, a total of four (4) experiments were conducted using a control (“CON WHEAT”) comprising the wheat forage feed with no added tannins, using a first feed composition containing MGM1, using a second feed composition containing MGM3, using a third feed composition containing MGM5, and using a blank. MGM1, MGM3, and MGM5, each comprise a mixture of one or more HTs and one or more PAs. MGM1, MGM3, and MGM5, are sold in commerce by UNITAN SAICA, Paseo Colon 221, Buenos Aires, Argentina. MGM1 comprises about 70 weight percent tannins. MGM3 comprises about 60 weight percent tannins. MGM5 comprises about 40 weight percent tannins. The experimental samples for Example I were prepared as follows:

1. Weigh out a 0.5-g sample and place into a labeled 50-mL centrifuge tube. The wheat forage was air dried for 72 hour, and treatment samples were mixed at about a 1.0% tannin inclusion on a dry matter basis.

2. To this tube, add 28 mL of the McDougall's solution. Prewarm McDougall's in 39° C. H₂O bath. Add 7 mL of ruminal fluid (can alter quantity, but use 4:1 ratio of buffer to ruminal fluid). Place ruminal fluid on stir plate to avoid settling. Ruminal fluid is strained through four layers of cheesecloth before use. If possible, ruminal fluid should be obtained from at least two animals.

3. Flush tube with CO₂ (gently so sample is not blown out). Place cap on tube, invert several times to suspend the sample, then place tubes into a rack, and place the rack into a 39° C. water bath.

4. Also include at least four blanks (tubes containing no sample and 35 mL of the McDougall's to ruminal fluid mixture). Include two blanks per time interval if rates of digestion are to be determined. Include 0.5-g samples of lab standards.

5. Incubate the tubes for 48 hours.

6. Invert the tubes at 2, 4, 20, and 28 hours after initiation of incubation to suspend the sample.

7. After 48 hours of incubation, remove the tubes from the water bath. Centrifuge for 15 min at 3000 x g and suction off the liquid by vacuum. At this point, one may freeze samples until they can be filtered or until the pepsin digestion can be completed.

8. If doing the acid pepsin digestion, mix the pepsin solution, and add 35 mL of pepsin solution to each tube. Incubate for 48 h in a 39° C. water bath, shaking at 2, 4, and 6 hours after pepsin addition.

9. After the completion of the digestion (either McDougall's and ruminal fluid or the pepsin solution digestion), filter samples using the modified Buchner funnel and ashless filter paper.

10. Dry the filter paper containing the sample in an aluminum pan for 12 to 24 hours. Record weights.

11. Ash each sample and record the weights. Ash at 500° C. for 4 hours.

12. Complete calculations.

TABLE I shows the IVDMD results of Example I after six (6) hours of incubation.

TABLE I
SIX (6) HOUR INCUBATION AT 1% TANNIN INCLUSION

| | | Initial Sample | Filter Paper | Filter Paper + | Final Sample | Sample | IVDMD |
|---|---|---|---|---|---|---|---|
| Trt | Tube # | Wt | Wt | Dry Sample | Wt | % DM | % |
| CON Wheat | 1 | 0.4986 | 1.3206 | 1.5361 | 0.2155 | 89.35 | 69.41 |
| CON Wheat | 2 | 0.4943 | 1.2829 | 1.5119 | 0.2290 | 89.35 | 66.08 |
| CON Wheat | 3 | 0.4945 | 1.2997 | 1.5413 | 0.2416 | 89.35 | 63.24 |
| CON Wheat | 4 | 0.5044 | 1.2901 | 1.5332 | 0.2431 | 89.35 | 63.63 |
| MCM1 | 5 | 0.5070 | 1.3300 | 1.5524 | 0.2224 | 89.35 | 68.39 |
| MGM1 | 6 | 0.4947 | 1.2831 | 1.5200 | 0.2369 | 89.35 | 64.32 |
| MGM1 | 7 | 0.4910 | 1.3050 | 1.5459 | 0.2409 | 89.35 | 63.14 |
| MGM1 | 8 | 0.4919 | 1.2598 | 1.5059 | 0.2461 | 89.35 | 62.03 |
| MGM3 | 9 | 0.5078 | 1.2744 | 1.5290 | 0.2546 | 89.54 | 61.42 |
| MGM3 | 10 | 0.4991 | 1.3150 | 1.5664 | 0.2514 | 89.54 | 61.47 |
| MGM3 | 11 | 0.4927 | 1.2798 | 1.5344 | 0.2546 | 89.54 | 60.24 |
| MGM3 | 12 | 0.5088 | 1.2774 | 1.5535 | 0.2761 | 89.54 | 56.78 |
| MGM5 | 13 | 0.5039 | 1.2522 | 1.5209 | 0.2687 | 89.47 | 57.97 |
| MGM5 | 14 | 0.5069 | 1.3033 | 1.5711 | 0.2678 | 89.47 | 58.41 |
| MGM5 | 15 | 0.5065 | 1.2787 | 1.5529 | 0.2742 | 89.47 | 56.97 |
| MGM5 | 16 | 0.5098 | 1.3382 | 1.6200 | 0.2818 | 89.47 | 55.58 |
| Blank | 17 | | 1.2352 | 1.3129 | 0.0777 | | |
| Blank | 18 | | 1.2789 | 1.3556 | 0.0767 | | |
| Blank | 19 | | 1.3253 | 1.3979 | 0.0726 | | |
| Blank | 20 | | 1.3146 | 1.4044 | 0.0898 | | |

TABLE II shows the IVDMD results of Example I after twelve (12) hours of incubation.

TABLE II
TWELVE (12) HOUR INCUBATION AT 1% TANNIN INCLUSION

| | | Initial Sample | Filter Paper | Filter Paper + | Final Sample | Sample | IVDMD |
|---|---|---|---|---|---|---|---|
| Trt | Tube # | Wt | Wt | Dry Sample | Wt | % DM | % |
| CON Wheat | 21 | 0.5038 | 1.2949 | 1.5067 | 0.2118 | 89.35 | 67.79 |
| CON Wheat | 22 | 0.4967 | 1.3174 | 1.5356 | 0.2182 | 89.35 | 65.89 |
| CON Wheat | 23 | 0.4998 | 1.2734 | 1.4880 | 0.2146 | 89.35 | 66.91 |
| CON Wheat | 24 | 0.4922 | 1.2505 | 1.4520 | 0.2015 | 89.35 | 69.38 |
| MGM1 | 25 | 0.4993 | 1.3017 | 1.5113 | 0.2096 | 89.35 | 68.00 |
| MGM1 | 26 | 0.4941 | 1.3137 | 1.5229 | 0.2092 | 89.35 | 67.75 |
| MGM1 | 27 | 0.5016 | 1.2696 | 1.4907 | 0.2211 | 89.35 | 65.58 |
| MGM1 | 28 | 0.4922 | 1.2956 | 1.5097 | 0.2141 | 89.35 | 66.51 |
| MGM3 | 29 | 0.5072 | 1.3146 | 1.5176 | 0.2030 | 89.54 | 70.02 |
| MGM3 | 30 | 0.4911 | 1.2682 | 1.4892 | 0.2210 | 89.54 | 64.94 |
| MGM3 | 31 | 0.4961 | 1.2899 | 1.4886 | 0.1987 | 89.54 | 70.31 |
| MGM3 | 32 | 0.4925 | 1.2834 | 1.4991 | 0.2157 | 89.54 | 66.24 |
| MGM5 | 33 | 0.4949 | 1.3136 | 1.5293 | 0.2157 | 89.47 | 66.38 |
| MGM5 | 34 | 0.4982 | 1.3115 | 1.5300 | 0.2185 | 89.47 | 65.97 |
| MGM5 | 35 | 0.5002 | 1.2989 | 1.4914 | 0.1925 | 89.47 | 71.92 |
| MGM5 | 36 | 0.4944 | 1.2929 | 1.4975 | 0.2046 | 89.47 | 68.85 |
| Blank | 37 | | 1.3263 | 1.3975 | 0.0712 | | |
| Blank | 38 | | 1.3085 | 1.3856 | 0.0771 | | |
| Blank | 39 | | 1.2933 | 1.3507 | 0.0574 | | |
| Blank | 40 | | 1.3097 | 1.3713 | 0.0616 | | |

TABLE III shows the IVDMD results of Example I after twenty-four (24) hours of incubation.

TABLE III
TWENTY-FOUR (24) HOUR INCUBATION AT 1% TANNIN INCLUSION

| | | Initial Sample | Filter Paper | Filter Paper + | Final Sample | Sample | IVDMD |
|---|---|---|---|---|---|---|---|
| Trt | Tube # | Wt | Wt | Dry Sample | Wt | % DM | % |
| CON Wheat | 41 | 0.4928 | 1.3487 | 1.5056 | 0.1569 | 89.35 | 80.62 |
| CON Wheat | 42 | 0.5006 | 1.3009 | 1.4678 | 0.1669 | 89.35 | 78.69 |
| CON Wheat | 43 | 0.4940 | 1.3436 | 1.5224 | 0.1788 | 89.35 | 75.71 |
| CON Wheat | 44 | 0.5031 | 1.3064 | 1.5053 | 0.1989 | 89.35 | 71.68 |
| MGM1 | 45 | 0.5006 | 1.3026 | 1.4886 | 0.1860 | 89.35 | 74.42 |
| MCM1 | 46 | 0.4978 | 1.2991 | 1.4829 | 0.1838 | 89.35 | 74.77 |
| MGM1 | 47 | 0.4988 | 1.3114 | 1.4903 | 0.1789 | 89.35 | 75.92 |
| MGM1 | 48 | 0.5039 | 1.3107 | 1.4950 | 0.1843 | 89.35 | 74.96 |
| MGM3 | 49 | 0.4936 | 1.3037 | 1.4862 | 0.1825 | 89.54 | 74.90 |
| MGM3 | 50 | 0.4980 | 1.3047 | 1.4894 | 0.1847 | 89.54 | 74.63 |
| MGM3 | 51 | 0.5097 | 1.3093 | 1.4996 | 0.1903 | 89.54 | 73.99 |
| MGM3 | 52 | 0.5082 | 1.3083 | 1.4889 | 0.1806 | 89.54 | 76.04 |
| MGM5 | 53 | 0.4918 | 1.3309 | 1.5116 | 0.1807 | 89.47 | 75.20 |
| MGM5 | 54 | 0.4967 | 1.2878 | 1.4659 | 0.1781 | 89.47 | 76.03 |
| MGM5 | 55 | 0.5026 | 1.3135 | 1.5234 | 0.2099 | 89.47 | 69.24 |
| MGM5 | 56 | 0.5045 | 1.3039 | 1.4805 | 0.1766 | 89.47 | 76.73 |
| Blank | 57 | | 1.3244 | 1.3910 | 0.0666 | | |
| Blank | 58 | | 1.2763 | 1.3439 | 0.0676 | | |
| Blank | 59 | | 1.3328 | 1.4095 | 0.0767 | | |
| Blank | 60 | | 1.3115 | 1.3869 | 0.0754 | | |

TABLE IV shows the IVDMD results of Example I after forty-eight (48) hours of incubation.

TABLE IV
FORTY-EIGHT (48) HOUR INCUBATION AT 1% TANNIN INCLUSION

| | | Initial Sample | Filter Paper | Filter Paper + | Final Sample | Sample | IVDMD |
|---|---|---|---|---|---|---|---|
| Trt | Tube # | Wt | Wt | Dry Sample | Wt | % DM | % |
| CON Wheat | 61 | 0.4973 | 1.3425 | 1.4672 | 0.1247 | 89.35 | 84.39 |
| CON Wheat | 62 | 0.5058 | 1.2948 | 1.4341 | 0.1393 | 89.35 | 81.42 |
| CON Wheat | 63 | 0.5047 | 1.3287 | 1.4619 | 0.1332 | 89.35 | 82.73 |
| CON Wheat | 64 | 0.4992 | 1.2833 | 1.4082 | 0.1249 | 89.35 | 84.40 |
| MGM1 | 65 | 0.4936 | 1.3359 | 1.4646 | 0.1287 | 89.35 | 83.36 |
| MGM1 | 66 | 0.4919 | 1.3164 | 1.4601 | 0.1437 | 89.35 | 79.89 |
| MGM1 | 67 | 0.4923 | 1.3135 | 1.4580 | 0.1445 | 89.35 | 79.73 |
| MGM1 | 68 | 0.4965 | 1.3232 | 1.4660 | 0.1428 | 89.35 | 80.28 |
| MGM3 | 69 | 0.4925 | 1.3258 | 1.4595 | 0.1337 | 89.54 | 82.23 |
| MGM3 | 70 | 0.5052 | 1.2936 | 1.4382 | 0.1446 | 89.54 | 80.26 |
| MGM3 | 71 | 0.5034 | 1.2959 | 1.4532 | 0.1573 | 89.54 | 77.38 |
| MGM3 | 72 | 0.4956 | 1.2665 | 1.4164 | 0.1499 | 89.54 | 78.69 |
| MGM5 | 73 | 0.5077 | 1.2793 | 1.4357 | 0.1564 | 89.47 | 77.75 |
| MGM5 | 74 | 0.4970 | 1.2853 | 1.4462 | 0.1609 | 89.47 | 76.26 |
| MGM5 | 75 | 0.4943 | 1.3359 | 1.4860 | 0.1501 | 89.47 | 78.57 |
| MGM5 | 76 | 0.4979 | 1.2705 | 1.4077 | 0.1372 | 89.47 | 81.62 |
| Blank | 77 | | 1.2668 | 1.3222 | 0.0554 | | |
| Blank | 78 | | 1.2864 | 1.3396 | 0.0532 | | |
| Blank | 79 | | 1.3096 | 1.3594 | 0.0498 | | |
| Blank | 80 | | 1.3276 | 1.3905 | 0.0629 | | |

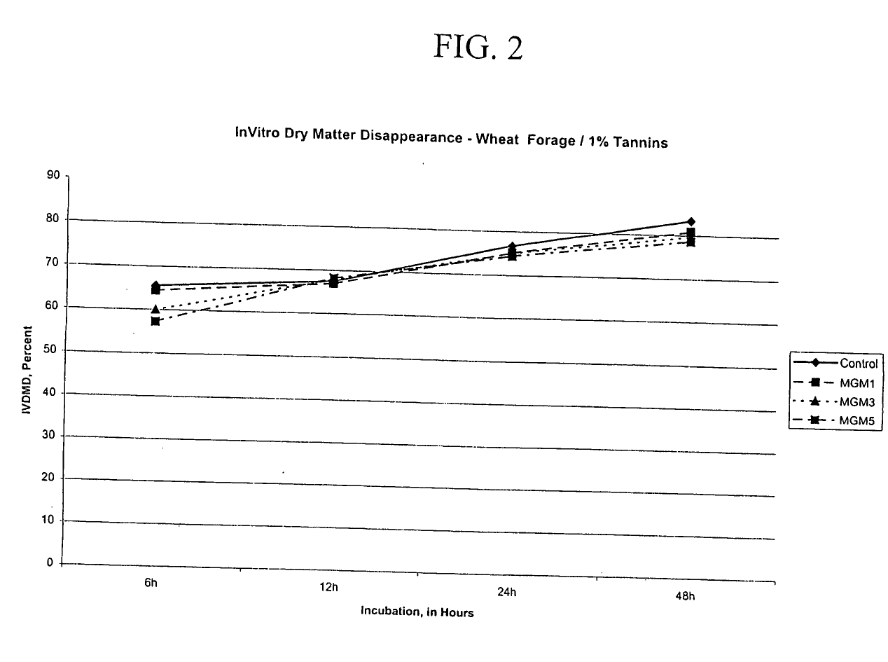

FIG. 2 graphically depicts the IVDMD data recited in TABLES I, II, III, and IV. As FIG. 2 shows, inclusion of tannins in a wheat forage-based animal feed can adjust the digestibility/fermentation of that wheat forage/tannin feed in the rumen. Therefore, Applicants have found that inclusion of tannins in animal feed can adjust the digestion of that feed. In ruminat animals, inclusion of tannins in the animal feed can adjust the amount of digestion that occurs in the rumen and the amount of digestion that occurs post-rumen. Thus, inclusion of tannins in animal feed can be used to adjust rumen-bypass of feed compositions containing those tannins.

In certain embodiments of Applicants' method to adjust the digestibility of animal feed comprises adding one or more tannins to animal feed, where those one or more tannins are present in an amount of about 1 weight percent. In other embodiments, the one or more tannins are present in the feed composition in an amount less than about 1 weight percent. In other embodiments, the one or more tannins are present in the feed composition in an amount greater than about 1 weight percent.

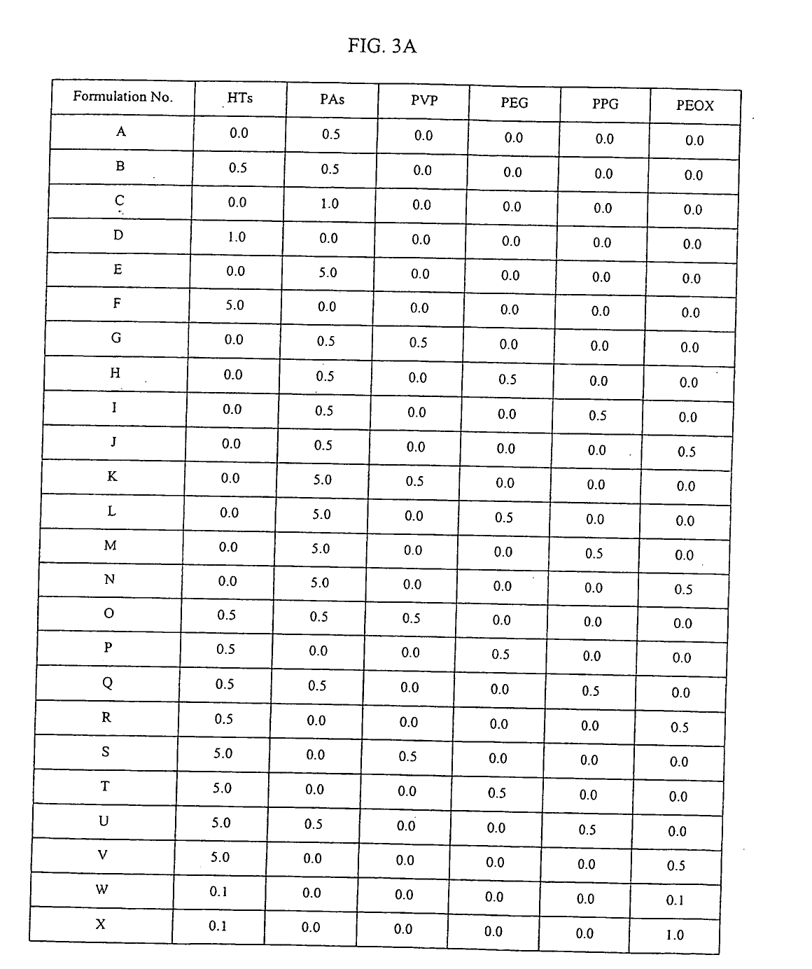

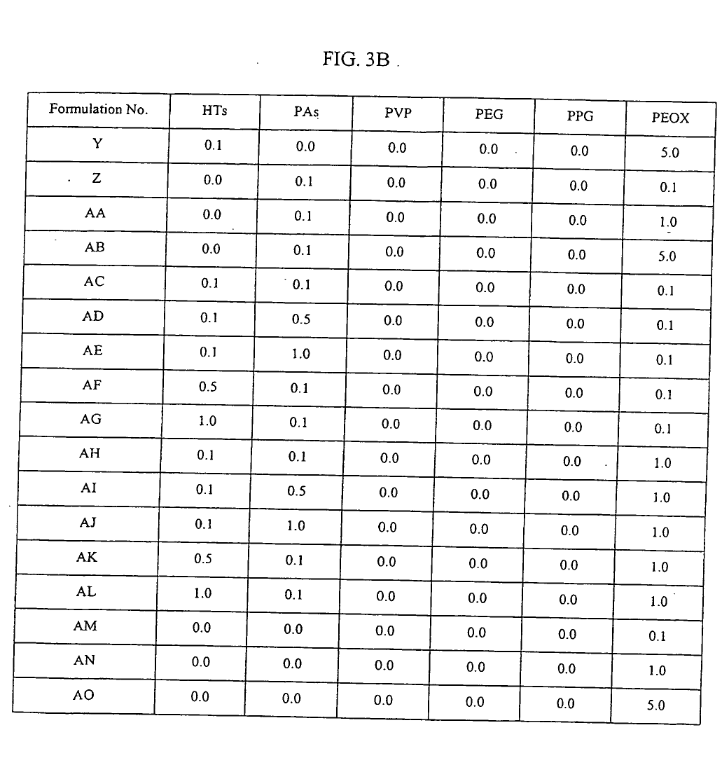

FIG. 3A summarizes Applicants' feed compositions A through X. FIG. 3B summarizes Applicants' feed compositions Y through AO. The quantities of the ingredients recited in FIGS. 3A and 3B are in parts, and are based upon 100 parts of animal feed. The remainder of the feed compositions of FIGS. 3A and 3B comprises other feedstuffs fed to ruminants. In FIGS. 3A and 3B, “PVP” means poly-N-vinylpyrrolidone, compound VI. The PVP used in Applicants' formulations has a number average molecular weight between about 1,000 and about 1,000,000.

“PEG” refers to polyethylene glycol, compound VII. The PEG used in Applicants' formulations has a number average molecular weight between about 500 and about 1,000,000.

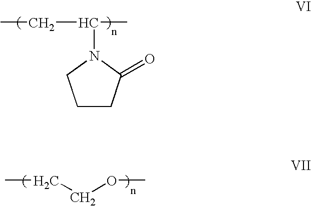

“PPG” refers to polypropylene glycol, compound VIII. The PPG used in Applicants' formulations has a molecular weight between about 500 and about 1,000,000.

“PEOX” refers to poly-2-ethyl-2-oxazoline, compound IX. The PEOX used in Applicants' formulations has a number average molecular weight between about 500 and about 1,000,000.

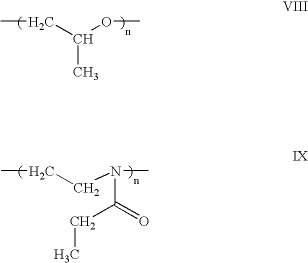

Poly-2-ethyl-2-oxazoline (“PEOX”) IX is a substituted polyethyleneimine. PEOX is formed by the ring-opening polymerization of 2-ethyl-2-oxazoline X.

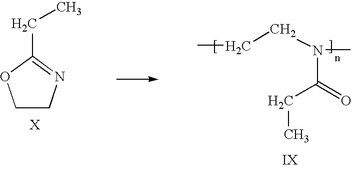

Monomer X is prepared using known procedures from propionic acid XI and ethanolamine XII via the intermediate hydroxyamide XIII.

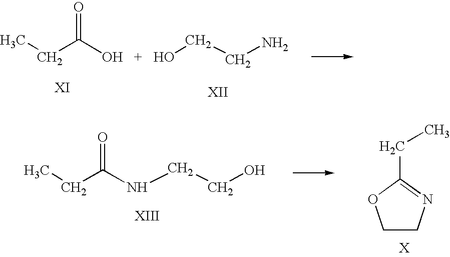

In certain embodiments of Applicants' composition and method, a commercially available PEOX having a molecular weight of about 50,000 is used. This polymeric material is sold in commerce under the name AQUAZOL® 50 by Polymer Chemistry Innovations, Inc., 4231 South Fremont, Tucson, Ariz. 85714. In certain embodiments of Applicants' composition and method, a commercially available PEOX having a molecular weight of about 200,000 is used. This polymeric material is sold in commerce under the name AQUAZOL® 200 by Polymer Chemistry Innovations, Inc., 4231 South Fremont, Tucson, Ariz. 85714.

Applicants' feed composition comprises any known feed material for ruminant animals, such as corn, in combination with a PEOX material having any molecular weight. In certain embodiments, Applicants' feed composition is formed by mixing the dry feed material with solid PEOX material and mixing those ingredients. In other embodiments, Applicants' feed composition is formed by mixing the dry feed material with a solution containing the PEOX polymer. Such a PEOX solution may contain PEOX from about one weight percent to about fifty weight percent. In certain embodiments, these PEOX solutions are aqueous solutions. In other embodiments, the PEOX is mixed in a non-aqueous liquid.

Certain embodiments of Applicants' composition include feed materials comprising steam-flaked corn and between about 1 weight percent and about 5 weight percent PEOX 50,000. Alternative embodiments of Applicants' composition include feed materials comprising steam-flaked corn and less than about 1 weight percent PEOX 50,000. In yet other embodiments, Applicants' feed composition comprises steam-flaked corn and more than about 5 weight percent PEOX 50,000.

Certain embodiments of Applicants' composition include feed materials comprising ground corn and between about 1 weight percent and about 5 weight percent PEOX 50,000. Alternative embodiments of Applicants' composition include feed materials comprising ground corn and less than about 1 weight percent PEOX 50,000. In yet other embodiments, Applicants' feed composition comprises ground corn and more than about 5 weight percent PEOX 50,000.

Certain embodiments of Applicants' composition include feed materials comprising steam-flaked corn and between about 1 weight percent and about 5 weight percent PEOX 200,000. Alternative embodiments of Applicants' composition include feed materials comprising steam-flaked corn and less than about 1 weight percent PEOX 200,000. In yet other embodiments, Applicants' feed composition comprises steam-flaked corn and more than about 5 weight percent PEOX 200,000.

Certain embodiments of Applicants' composition include feed materials comprising ground corn and between about 1 weight percent and about 5 weight percent PEOX 200,000. Alternative embodiments of Applicants' composition include feed materials comprising ground corn and less than about 1 weight percent PEOX 200,000. In yet other embodiments, Applicants' feed composition comprises ground corn and more than about 5 weight percent PEOX 200,000.

The following examples are presented to further illustrate to persons skilled in the art how to make and use the invention and to identify presently preferred embodiments thereof. These examples are not intended as a limitation, however, upon the scope of Applicants' invention.

Approximately 2 kg of steam-flaked corn (density of approximately 360 g/L) and 2 kg of ground corn (finely ground through a hammer mill) were obtained from the Texas Tech University Burnett Center Feed Mill. The steam-flaked corn was dried overnight at 50° C. and subsequently ground to pass a 2-mm screen in a Wiley mill. The ground corn was similarly ground to pass a 2-mm screen. After grinding, the steam-flaked and ground corns were mixed with PEOX to yield 50 g of substrate with either about 1% or about 5% (dry matter basis) of PEOX 50,000 and about 1% or about 5% (dry matter basis) of PEOX 200,000. Samples of steam-flaked and ground corn that did not contain PEOX served as the Control substrate. To provide PEOX in a soluble form for addition to in vitro dry matter disappearance (IVDMD) cultures, aqueous solutions containing 5 and 25 mg/mL of both PEOX 50,000 and PEOX 200,000 were prepared in volumetric flasks.

For each tannin material, two IVDMD experiments were conducted. The basic IVDMD procedures (described below) were the same in each experiment. Each experiment consisted of two IVDMD runs conducted on separate days.

### EXAMPLE II

Treatments in EXAMPLE I included: (i) Control steam-flaked corn substrate, (ii) 1% loading of PEOX 50,000 in steam-flaked corn substrate, (iii) 5% loading of PEOX 50,000 in steam-flaked corn substrate, (iv) 1% loading of PEOX 200,000 in steam-flaked corn substrate, and (v) 5% loading of PEOX 200,000 in steam-flaked corn substrate.

### EXAMPLE III

Treatments in EXAMPLE II included: (i) Control steam-flaked corn substrate, (ii) 1% loading of PEOX 50,000 in steam-flaked corn substrate, (iii) 5% loading of PEOX 50,000 in steam-flaked corn substrate, (iv) 1% loading of PEOX 200,000 in steam-flaked corn substrate, (v) 5% loading of PEOX 200,000 in steam-flaked corn substrate, (vi) 1% loading of PEOX 50,000 in ground corn substrate, (vii) 5% loading of PEOX 50,000 in ground corn substrate, (viii) 1% loading of PEOX 200,000 in ground corn substrate, (ix) 5% loading of PEOX 200,000 in ground corn substrate, (x) Control steam-flaked corn substrate and 1 mL of water added to the culture, (xi) Control steam-flaked corn substrate and 1 mL of PEOX 50,000 (5 mg/mL) added to the culture, (xii) Control steam-flaked corn substrate and 1 mL of PEOX 50,000 (25 mg/mL) added to the culture, (xiii) Control steam-flaked corn substrate and 1 mL of PEOX 200,000 (5 mg/mL) added to the culture, (xiv) Control steam-flaked corn substrate and 1 mL of PEOX 200,000 (25 mg/mL) added to the culture. In experiments (x), (xi), (xii), (xiii), and (xiv), water or PEOX solutions were added after a buffer: ruminal fluid mixture and urea had been added to the IVDMD culture tube.

Within each IVDMD run, duplicate culture tubes were incubated per treatment in a water bath at 39° C. for 4, 8, 12, or 24 h. The IVDMD cultures consisted of 0.5 g of treatment substrates plus 30 mL of a 4:1 mixture of McDougall's artificial saliva buffer/ruminal fluid. Ruminal fluid was collected from two ruminally cannulated cattle (one steer and one heifer) that were fed a 90% concentrate, steam-flaked corn-based diet. After addition of the buffer/ruminal fluid mixture, 1 mL of a 1% (wt/vol) solution of urea was added to each culture to ensure that nitrogen content of the substrate did not limit culture activity. Triplicate blank (no substrate) culture tubes were included for each incubation time to correct for indigestible dry matter added by the ruminal fluid. After the assigned ruminal incubation period, culture tubes were frozen to stop fermentation. Once all incubation periods were completed, frozen tubes were thawed and centrifuged at 1,000 x g. The supernatant fluid was aspirated and discarded, after which 30 mL of acidified pepsin were added, and each tube was incubated 48 h at 39° C. After the pepsin incubation, the contents of each tube were filtered through Whatman No. 541 filter paper. The dry matter content of each substrate was determined by drying overnight in a forced-air oven at 100° C. The filter paper+residue was dried at 100° C. overnight in a forced-air oven. The IVDMD was calculated from the original dry substrate weight and the residue weight, corrected for the blank residue weight.

TABLE V
Least Square Means for the Effect of 1% PEOX Inclusion on
IVDMD of Steam-Flaked Corn

| Incubation | | 50,000 MW | 200,000 MW | |
|---|---|---|---|---|
| (Hours) | Control | PEOX | PEOX | SEM |
| 4 | 42.37 | 46.96 | 46.23 | 1.39 |
| 8 | 52.88 | 54.96 | 55.45 | 1.34 |
| 12 | 63.02 | 65.64 | 65.13 | 1.44 |
| 24 | 69.25 | 74.17 | 73.06 | 1.63 |

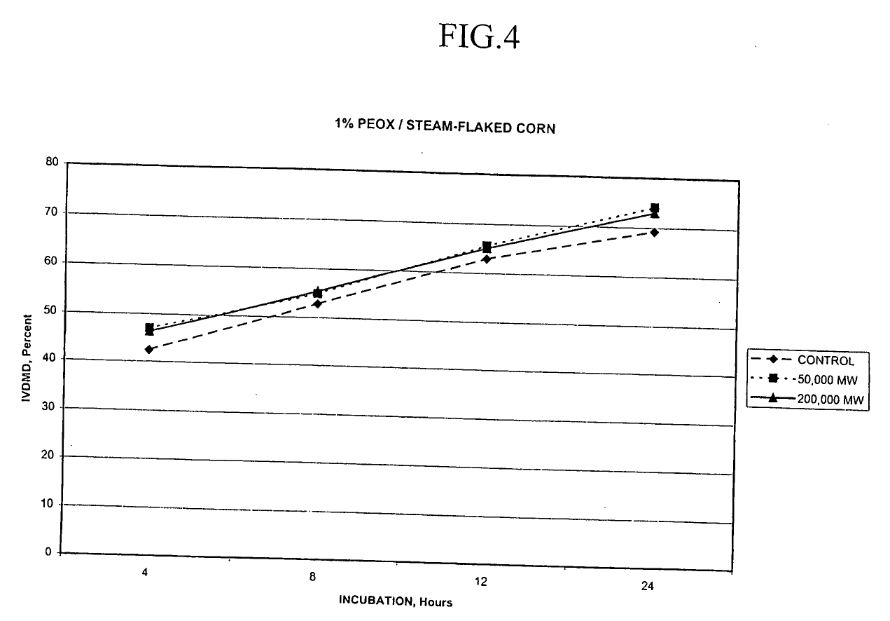

FIG. 4 graphically depicts certain data from EXAMPLE II as recited in TABLE V. As both FIG. 4 and TABLE V clearly show, addition of about one weight percent of either 50,000 molecular weight PEOX or 200,000 molecular weight PEOX results in increased digestion of the steam-flaked corn feed material.

TABLE VI
Least Square Means for the Effect of 5% PEOX Inclusion on
JVDMD of Steam-Flaked Corn

| Incubation | | 50,000 MW | 200,000 MW | |
|---|---|---|---|---|
| (Hours) | Control | PEOX | PEOX | SEM |
| 4 | 42.37 | 46.53 | 46.94 | 2.47 |
| 8 | 52.88 | 57.00 | 57.57 | 1.25 |
| 12 | 63.02 | 63.53 | 65.53 | 1.46 |
| 24 | 69.25 | 74.07 | 73.64 | 1.46 |

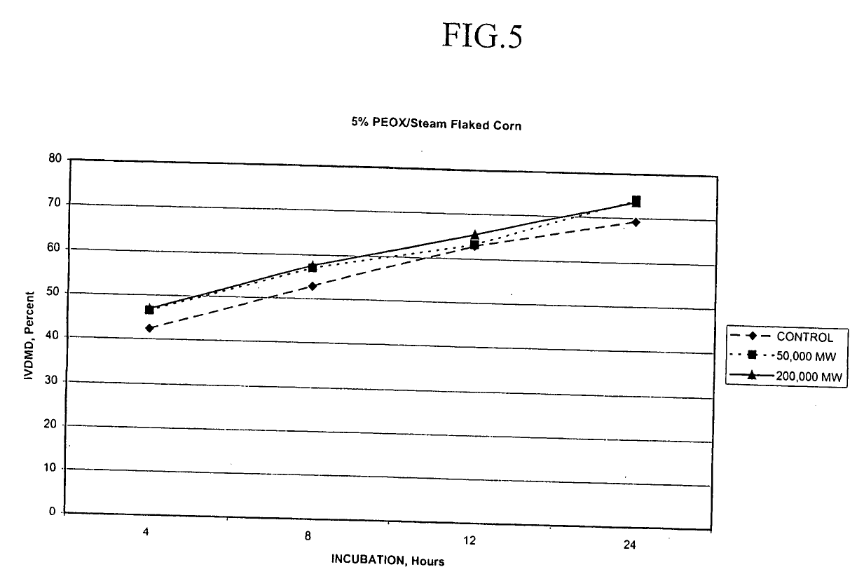

FIG. 5 graphically depicts certain data from EXAMPLE II as recited in TABLE VI. As both FIG. 5 and TABLE VI clearly show, addition of about five weight percent of either 50,000 molecular weight PEOX or 200,000 molecular weight PEOX results in increased digestion of the steam-flaked corn feed material.

TABLE VII
Effect of 1% PEOX inclusion on IVDMD of steam-flaked (SFC) and ground corn (GC)^{a}

| | Treatment | | | | | | | | | |
|---|---|---|---|---|---|---|---|---|---|---|
| | Dry mixtures | | | | | | Added by solution | | | |
| Incubation | SFC | | | | | | SFC | | SFC | |
| (Hours) | Con | SFC L | SFC H | GC Con | GC L | GC H | Con | SFC L | H | SEM |
| 4 | 49.77 | 51.35 | 50.45 | 37.76 | 36.42 | 36.52 | 45.89 | 50.52 | 47.69 | 1.44 |
| 8 | 58.78 | 62.19 | 61.45 | 47.84 | 51.97 | 49.92 | 58.27 | 65.03 | 64.77 | 2.44 |
| 12 | 66.70 | 70.60 | 67.56 | 58.82 | 61.67 | 59.66 | 65.80 | 72.08 | 72.51 | 2.49 |
| 24 | 74.38 | 78.62 | 78.06 | 73.09 | 75.88 | 77.02 | 73.99 | 79.69 | 79.99 | 2.33 |

a L indicates 50,000 MW PEOX; H indicates 200,000 MW PEOX

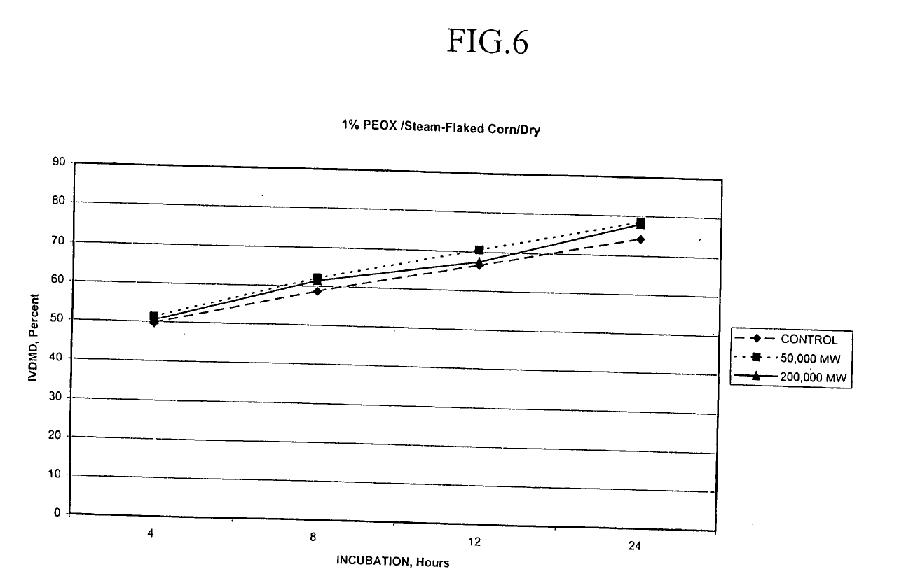

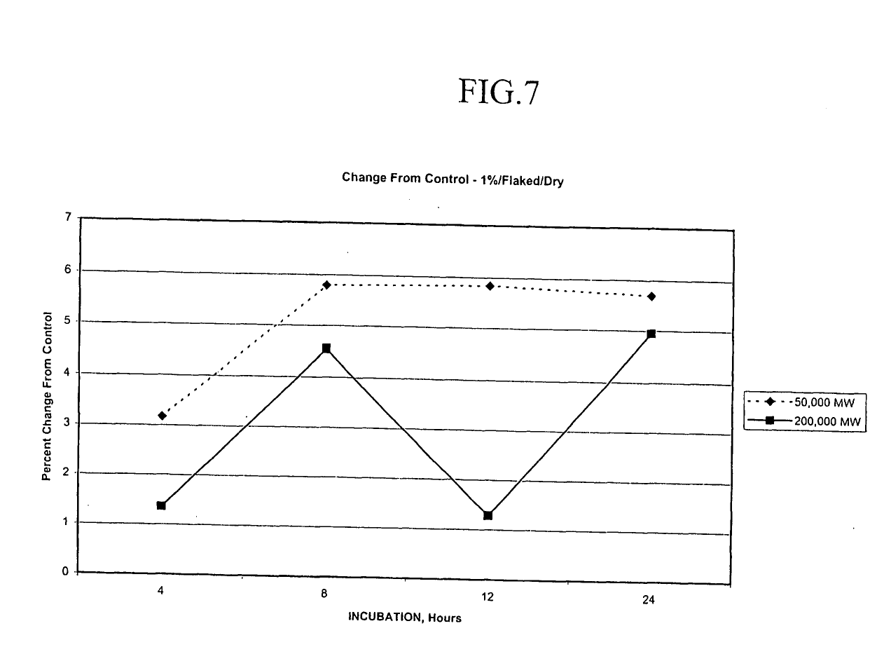

FIG. 6 graphically depicts data obtained in EXAMPLE III, and recited in TABLE VII, regarding addition of about one weight percent PEOX to steam-flaked corn, where that PEOX was added as a dry material. FIG. 7 shows the increased digestion of the treated feed material in relation to the uptake of the control feed material. FIGS. 6 and 7 indicate that inclusion of the 50,000 molecular weight PEOX gives between about a 3% to about a 6% increased digestion over the control. FIGS. 6 and 7 indicate that inclusion of the 200,000 molecular weight PEOX gives between about a 1% to about a 5% increased digestion over the control.

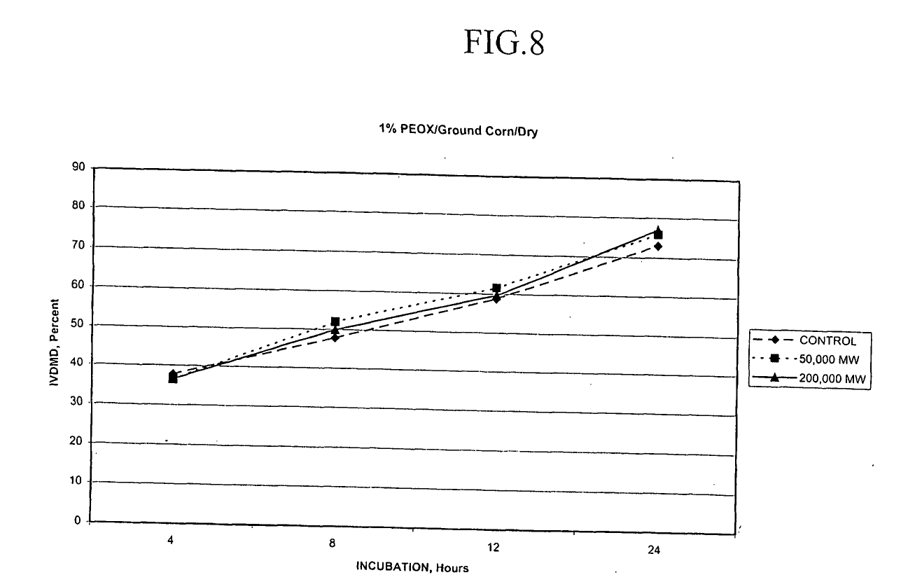

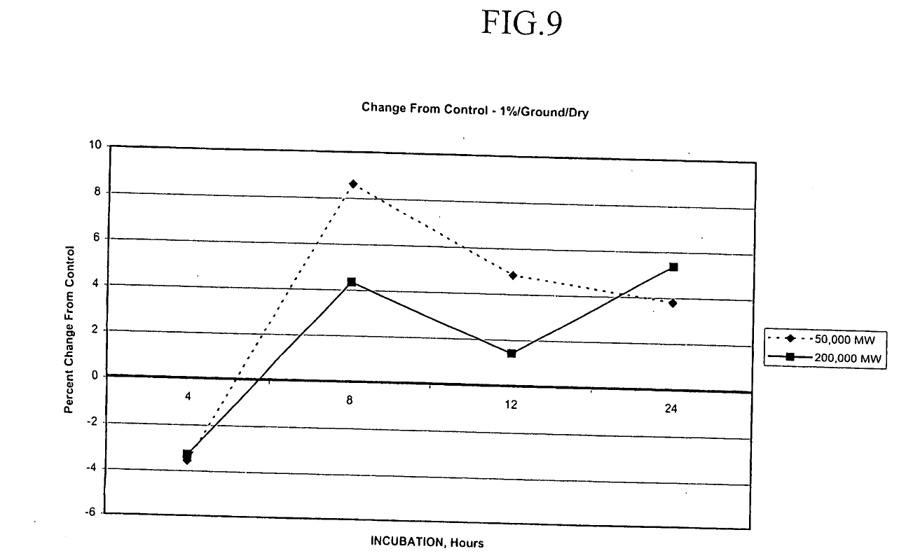

FIG. 8 graphically depicts data obtained in EXAMPLE III, and recited in TABLE VII, regarding addition of about one weight percent PEOX to ground corn, where that PEOX was added as a dry material. FIG. 9 shows the increased digestion of the treated feed material in relation to the uptake of the control feed material. FIGS. 8 and 9 indicate that inclusion of the 50,000 molecular weight PEOX gives up to about a 8.5% increased digestion over the control. FIGS. 8 and 9 indicate that inclusion of the 200,000 molecular weight PEOX gives up about a 5.5% increased digestion over the control.

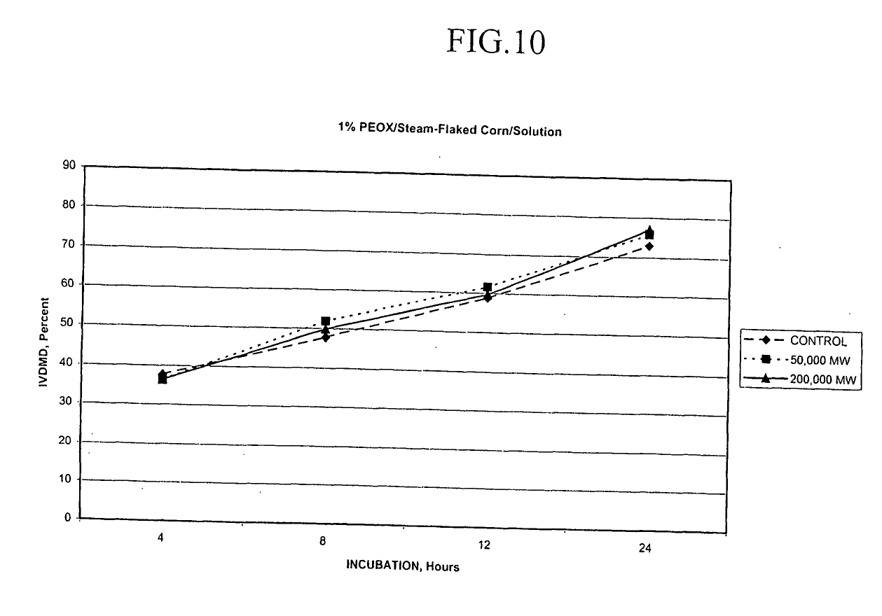

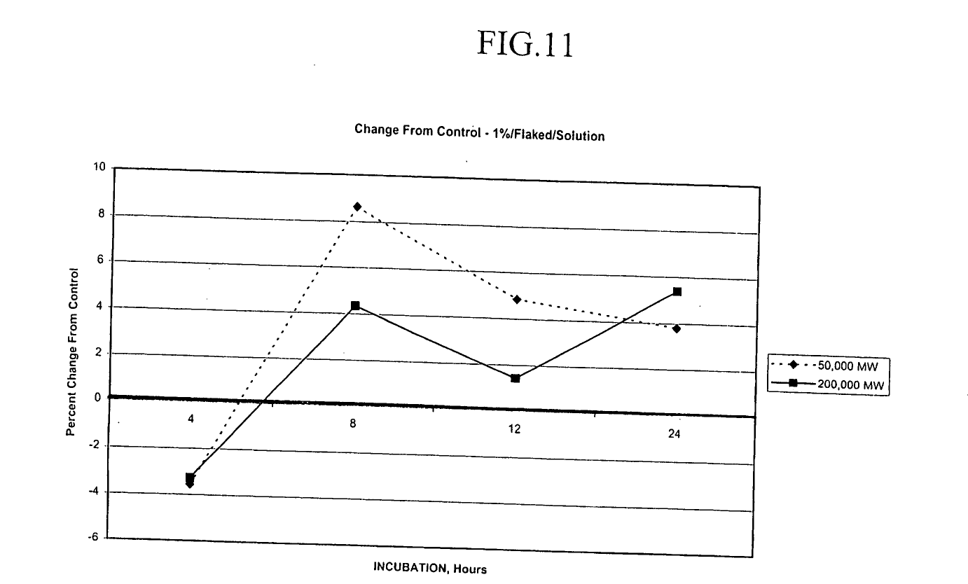

FIG. 10 graphically depicts data obtained in EXAMPLE III, and recited in TABLE VII, regarding addition of about one weight percent PEOX to steam-flaked corn, where that PEOX was added as a solution. FIG. 11 shows the increased digestion of the treated feed material in relation to the uptake of the control feed material. FIGS. 10 and 11 indicate that inclusion of the 50,000 molecular weight PEOX gives up to about a 9% increased digestion over the control. FIGS. 10 and 11 indicate that inclusion of the 200,000 molecular weight PEOX gives up about a 5.5% increased digestion over the control.

TABLE VIII
Effect of 5% (DM basis) PEOX inclusion on IVDMD of steam-flaked and ground corn^{a}

| | Treatment | | | | | | | | | |
|---|---|---|---|---|---|---|---|---|---|---|
| | Dry mixtures | | | | | | Added by solution | | | |
| Incubation | SFC | | | | | | SFC | | SFC | |
| (Hours) | Con | SFC L | SFC H | GC Con | GC L | GC H | Con | SFC L | H | SEM |
| 4 | 49.77 | 50.50 | 55.95 | 37.76 | 41.33 | 41.26 | 45.89 | 53.41 | 52.69 | 2.21 |
| 8 | 58.78 | 66.37 | 66.98 | 47.84 | 54.19 | 52.77 | 58.27 | 66.99 | 66.99 | 2.46 |
| 12 | 66.70 | 73.02 | 73.52 | 58.82 | 64.58 | 61.80 | 65.80 | 71.59 | 72.27 | 2.97 |
| 24 | 74.38 | 79.68 | 79.47 | 73.09 | 80.79 | 76.91 | 73.99 | 81.52 | 80.54 | 2.65 |

a L indicates 50,000 MW PEOX; H indicates 200,000 MW PEOX

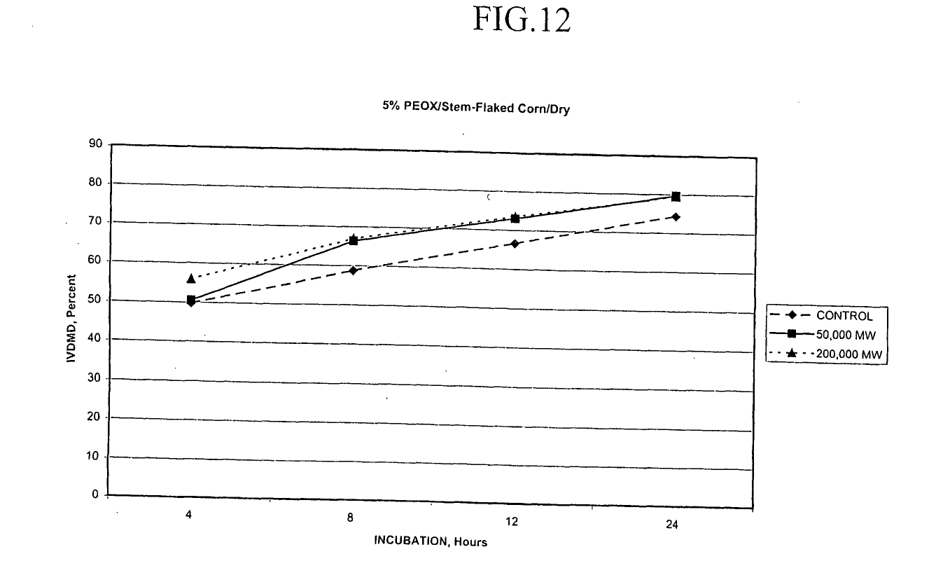

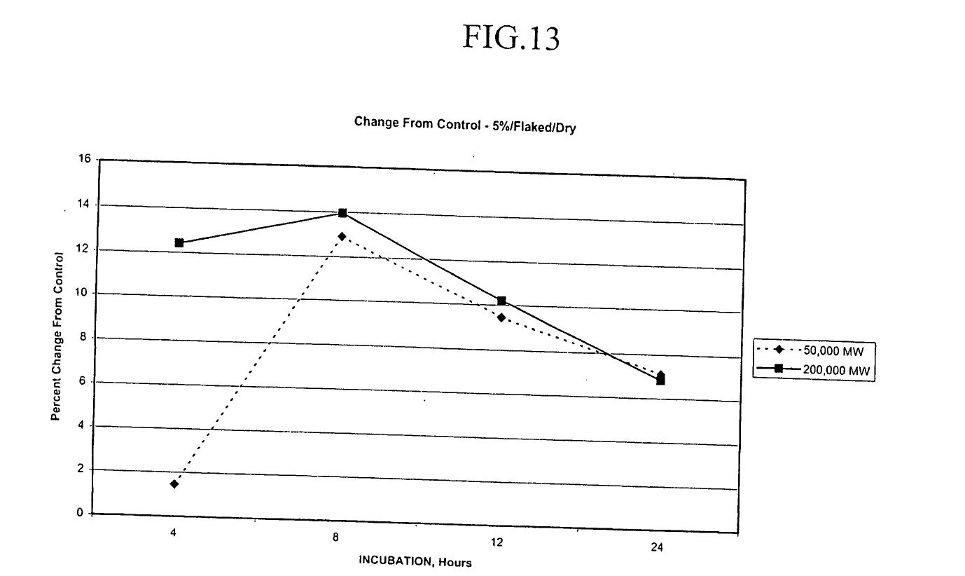

FIG. 12 graphically depicts data obtained in EXAMPLE III, and recited in TABLE VIII, regarding addition of about five weight percent PEOX to steam-flaked corn, where that PEOX was added as a dry material. FIG. 13 shows the increased digestion of the treated feed material in relation to the uptake of the control feed material. FIGS. 12 and 13 indicate that inclusion of the 50,000 molecular weight PEOX gives up to about a 14% increased digestion over the control. FIGS. 12 and 13 indicate that inclusion of the 200,000 molecular weight PEOX gives up to about a 13% increased digestion over the control.

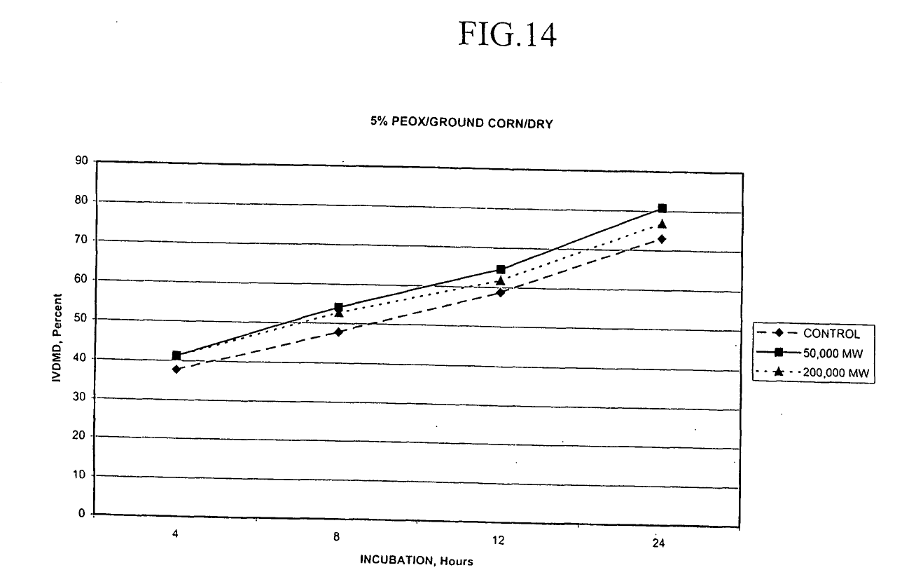

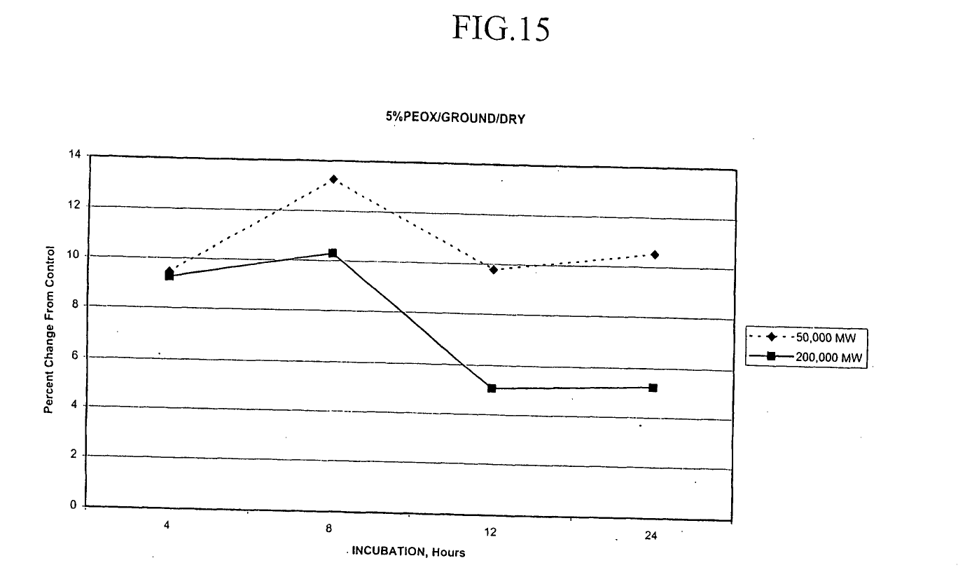

FIG. 14 graphically depicts data obtained in EXAMPLE III, and recited in TABLE VIII, regarding addition of about five weight percent PEOX to ground corn, where that PEOX was added as a dry material. FIG. 15 shows the increased digestion of the treated feed material in relation to the uptake of the control feed material. FIGS. 14 and 15 indicate that inclusion of the 50,000 molecular weight PEOX gives up to about a 13.5% increased digestion over the control. FIGS. 14 and 15 indicate that inclusion of the 200,000 molecular weight PEOX gives up to about a 10% increased digestion over the control.

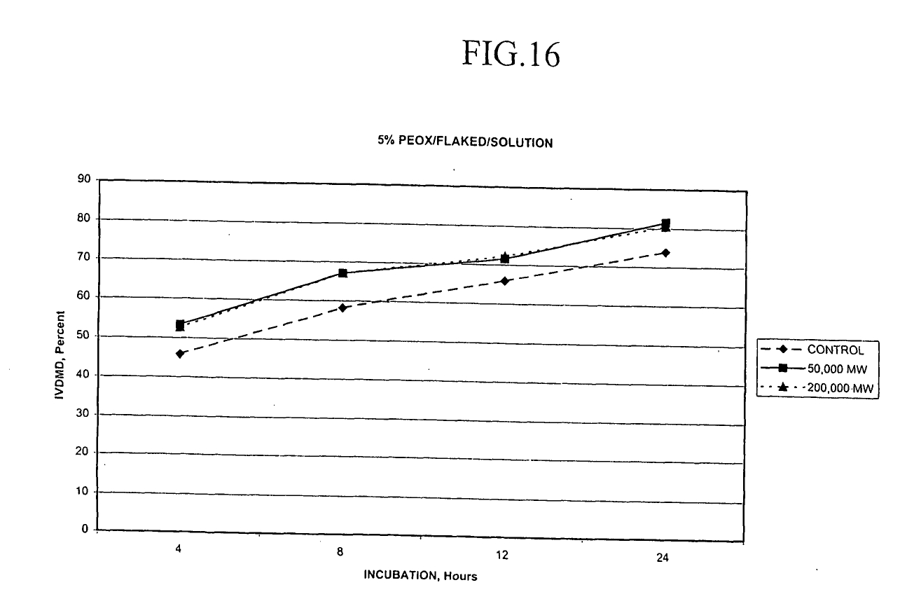

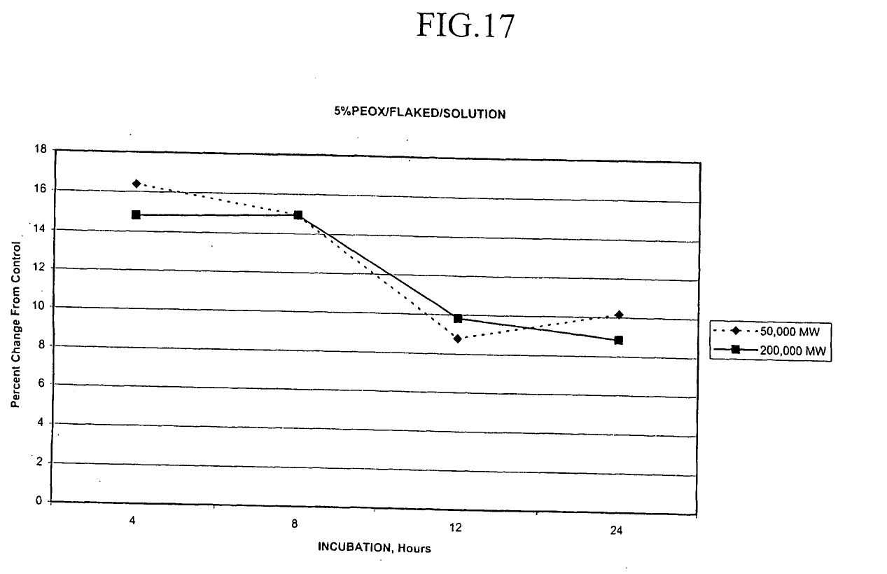

FIG. 16 graphically depicts data obtained in EXAMPLE III, and recited in TABLE VIII, regarding addition of about five weight percent PEOX to steam-flaked, where that PEOX was added as a solution. FIG. 17 shows the increased digestion of the treated feed material in relation to the uptake of the control feed material. FIGS. 16 and 17 indicate that inclusion of the 50,000 molecular weight PEOX gives up to about a 16.5% increased digestion over the control. FIGS. 16 and 17 indicate that inclusion of the 200,000 molecular weight PEOX gives up about a 15% increased digestion over the control.

As Examples II and III show, inclusion of PEOX in animal feed can be used to adjust the digestion of that feed. Moreover with respect to ruminate animals, inclusion of PEOX in animal feed can be used to increase the percentage of consumed feed digested in the rumen. As discussed above, inclusion of tannins in animal feed can be used to decrease the percentage of consumed feed digested in the rumen. Thus, by adding PEOX and/or tannins to animal feed, the percentage of animal feed digested in the rumen can be adjusted, upwardly or downwardly, to a desired level.

While the preferred embodiments of the present invention have been illustrated in detail, it should be apparent that modifications and adaptations to those embodiments may occur to one skilled in the art without departing from the scope of the present invention as set forth in the following claims.

We claim:

1. A feed composition for animals comprising poly-2-ethyl-2-oxazoline.

2. The feed composition of claim 1 further comprising starchy feedstuffs.

3. The feed composition of claim 1 further comprising forages.

4. The feed composition of claim 1, wherein said poly-2-ethyl-2-oxazoline has a molecular weight of about 200,000.

5. The feed composition of claim 1, wherein said poly-2-ethyl-2-oxazoline has a molecular weight of about 50,000.

6. The feed composition of claims 4 or 5, wherein said poly-2-ethyl-2oxazoline is present at a level of about 1 weight percent.

7. The feed composition of claims 4 or 5, wherein said poly-2-ethyl-2oxazoline is present at a level of about 5 weight percent.

8. The feed composition of claims 4 or 5, wherein said poly-2-ethyl-2oxazoline is present at a level less than 1 weight percent.

9. The feed composition of claims 4 or 5, wherein said poly-2-ethyl-2oxazoline is present at a level more than 5 weight percent.

10. A method to adjust the digestibility of food ingested by an animal, comprising the steps of:
forming a feed composition comprising poly-2-ethyl-2-oxazoline;
feeding said feed composition to said animal.

11. The method of claim 10, wherein said feed composition further comprises starchy feedstuffs.

12. The method of claim 10, wherein said feed composition further comprises forages.

13. The method of claim 10, wherein said poly-2-ethyl-2-oxazoline has a molecular weight of about 200,000.

14. The method of claim 10, wherein said poly-2-ethyl-2-oxazoline has a molecular weight of about 50,000.

15. The method of claims 13 or 14, wherein said poly-2-ethyl-2-oxazoline is present in said feed composition at a level of about 1 weight percent.

16. The method of claims 13 or 14, wherein said poly-2-ethyl-2-oxazoline is present in said feed composition at a level of about 5 weight percent.

17. The method of claims 13 or 14, wherein said poly-2-ethyl-2-oxazoline is present in said feed composition at a level less than 1 weight percent.

18. A method to adjust the digestibility of food ingested by an animal, comprising the steps of:
forming a feed composition comprising one or more tannins;
feeding said feed composition to said animal.

19. The method of claim 18, wherein said feed composition further comprises starchy feedstuffs.

20. The method of claim 18, wherein said feed composition further comprises forages.

21. The method of claim 18, wherein said one or more tannins comprises one or more hydrolyzable tannins.

22. The method of claim 18, wherein said one or more tannins comprises one or more proanthocyanidins.

23. The method of claim 18, wherein said one or more tannins are present in said feed composition at a level of about 1 weight percent.

24. The method of claim 18, further comprising the step of adding a water soluble polymer to said feed composition.

25. The method of claim 24, wherein said water soluble polymer comprising polyethylene glycol.

26. The method of claim 24, wherein said water soluble polymer comprises poly-N-vinylpyrrolidone.

27. The method of claim 24, wherein said water soluble polymer comprises poly-2-ethyl-2-oxazoline.

28. The method of claim 27, wherein said poly-2-ethyl-2-oxazoline has a molecular weight of about 200,000.

29. The method of claim 27, wherein said poly-2-ethyl-2-oxazoline has a molecular weight of about 50,000.

30. The method of claims 28 or 29, wherein said poly-2-ethyl-2-oxazoline is present in said feed composition at a level of about 1 weight percent.

31. The method of claims 28 or 29, wherein said poly-2-ethyl-2-oxazoline is present in said feed composition at a level of about 5 weight percent.

32. The method of claims 28 or 29, wherein said poly-2-ethyl-2-oxazoline is present in said feed composition at a level less than 1 weight percent.

33. The method of claims 28 or 29, wherein said poly-2-ethyl-2-oxazoline is present in said feed composition at a level more than 5 weight percent.
